(19) United States
(12) Patent Application Publication
(10) Pub. No.: US 2003/0078070 A1
(43) Pub. Date: Apr. 24, 2003

(54) Cover structure for mobile phone

(76) Inventor: Che-Yuan Hsu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/011,934

(22) Filed: Nov. 30, 2001

(30) Foreign Application Priority Data
Oct. 24, 2001 (TW) 90218219

(51) Int. Cl. H04M 1/00

(52) U.S. Cl. 455/550; 455/575

(57) ABSTRACT

A cover structure (10) of a mobile phone (1) includes an outer composite layer (7) that provides different visual effects according to different viewing angles, and an inner plastic substrate (15) attached to an inner side of the composite layer. The composite layer includes a facial layer (11), an optical polarizing film (12), a decorative layer (13) and an adhesion layer (14) in that sequence from an outer face of the composite layer to the plastic substrate. The facial layer, polarizing film, decorative layer and adhesion layer are heat pressed together to form the composite layer. The plastic substrate is plastic injection molded onto the adhesion layer, combining with the composite layer to form the cover structure. The cover structure having the polarizing film allows the mobile phone to provide different visual effects according to different viewing angels. The mobile phone is thus very aesthetically pleasing to users.

### FIELD OF THE INVENTION

The present invention relates to cover structures for mobile phones, and particularly to a cover structure for a mobile phone that provides different visual effects according to different angles of viewing.

### BACKGROUND OF THE INVENTION

At present, mobile phones typically have plastic cover structures which are formed by plastic injection molding.

Many users change the cover structures of their mobile phones from time to time for aesthetic purposes. Different cover structures having different colors or decorations enhance the attractiveness of mobile phones. Accordingly, users purchase extra cover structures for their mobile phones. This is unduly costly. Furthermore, the original cover structure needs to be removed from the mobile phone, and the replacement cover structure needs to be attached to the mobile phone. This is unduly time-consuming and inconvenient.

Therefore, an improved cover structure for a mobile phone that overcomes the above-mentioned disadvantages is desired.

### SUMMARY OF THE INVENTION

A main object of the present invention is to provide a cover structure for a mobile phone having different appearances according to different angles of viewing.

To achieve the above object, a mobile phone in accordance with the present invention comprises a cover structure, a display, a keypad and a printed circuit board (PCB) within the cover structure. The cover structure includes an outer composite layer that provides different visual effects according to different viewing angles, and an inner plastic substrate attached to an inner side of the composite layer. A speaker and a microphone are provided in the cover structure. The composite layer includes a facial layer, an optical polarizing film, a decorative layer and an adhesion layer in that sequence from an outer face of the composite layer to the plastic substrate. The facial layer, polarizing film, decorative layer and adhesion layer are heat pressed together to form the composite layer. The plastic substrate is plastic injection molded onto the adhesion layer, combining with the composite layer to form the cover structure. The cover structure having the polarizing film allows the mobile phone to provide different visual effects according to different viewing angles. The mobile phone is thus much more aesthetically pleasing to users compared with conventional mobile phones.

Other objects, advantages and novel features of the invention will become more apparent from the following detailed description of a preferred embodiment thereof when taken in conjunction with the accompanying drawings, wherein:

### BRIEF DESCRIPTION OF THE DRAWINGS

FIG. 1 is a front elevational view of a mobile phone in accordance with a preferred embodiment of the present invention;

FIG. 2 is a schematic cross-sectional view of a cover structure of the mobile phone of FIG. 1, during manufacturing of the cover structure by plastic injection molding; and

FIG. 3 is an enlarged view of a circled portion III of FIG. 2.

### DETAILED DESCRIPTION OF THE INVENTION

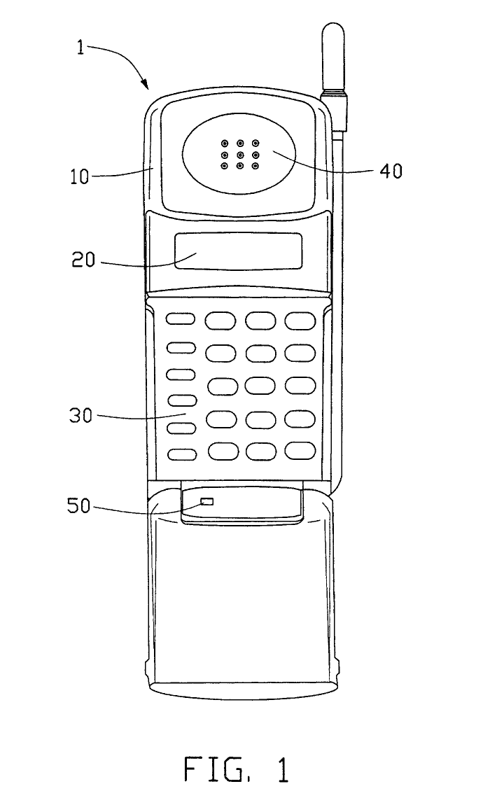

Referring now to the drawings in detail, FIG. 1 shows a mobile phone 1 in accordance with a preferred embodiment of the present invention. The mobile phone 1 comprises a cover structure 10, a display 20, a keypad 30 and a printed circuit board (PCB, not shown) within the cover structure 10. A speaker 40 and a microphone 50 are respectively provided at upper and lower parts of the cover structure 10.

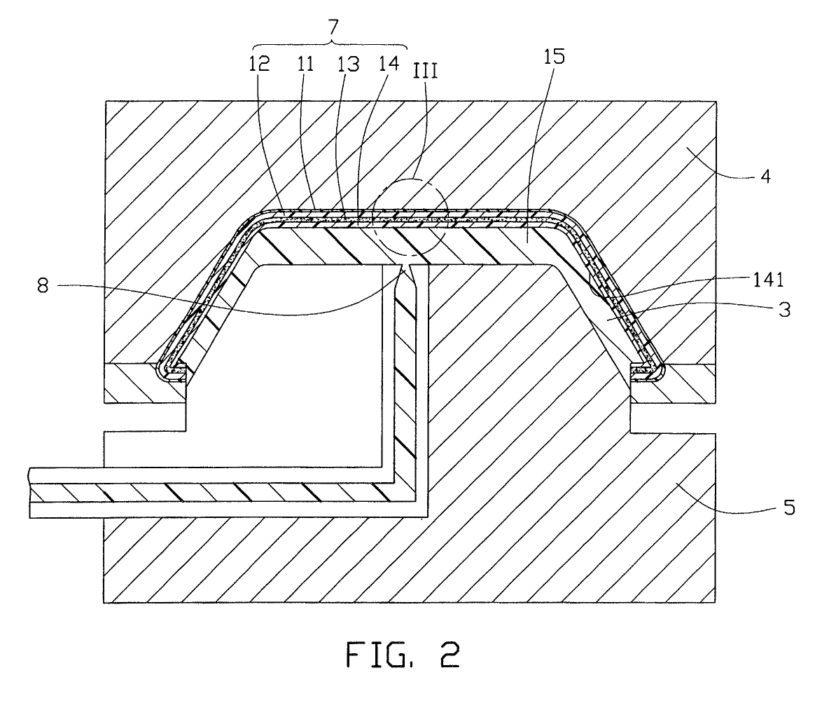

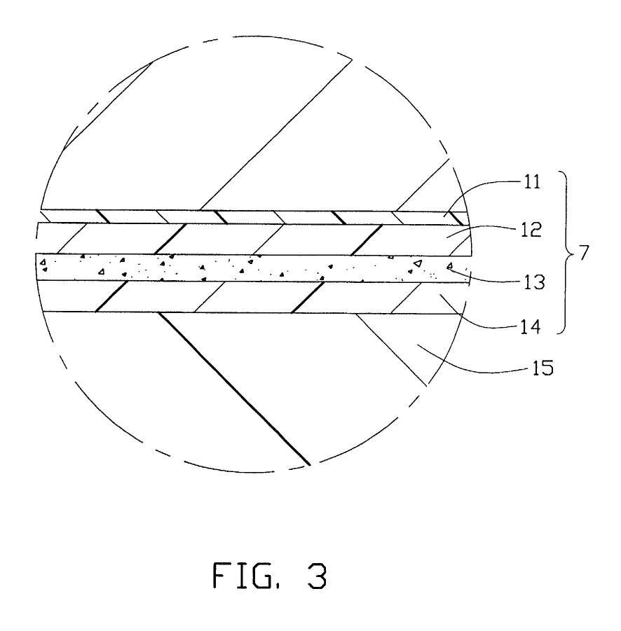

FIGS. 2 and 3 are cross-sectional views of the cover structure 10 when it is formed in upper and lower plastic injection molding molds 4, 5. The cover structure 10 comprises an outer composite layer 7 and an inner plastic substrate 15. The composite layer 7 comprises a facial layer 11, an optical polarizing film 12, a decorative layer 13 having two different kinds of decorative patterns or colors (not shown) thereon, and an adhesion layer 14 in that sequence from an outer face of the composite layer 7 to the plastic substrate 15. The facial layer 11 is a transparent film to protect the polarizing film 12. The polarizing film 12 is used to direct light reflected from the decorative layer 13 at two specific angles that are predetermined according to two kinds of decorative patterns or colors in the decorative layer 13. Thus, when a user views the cover structure 10 at a first angle of view, a first kind of decorative pattern or color is seen. When the user views the cover structure 10 at a second angle of view, a second kind of decorative pattern or color is seen. The adhesion layer 14 is made of plastic such as ABS, to protect the decorative layer 13 and to attach the composite layer 7 with the plastic substrate 15. The composite layer 7 is formed by individually preparing each of the constituting layers 11, 12, 13, 14 and then heat pressing these layers together. The plastic substrate 15 is made of ABS.

FIG. 2 shows part of a process for manufacturing the cover structure 10. First, the facial layer 11, polarizing film 12, decorative layer 13 and adhesion layer 14 are combined together by heat pressing to obtain the composite layer 7. The composite layer 7 has a generally concave inner face 141. A profile of the inner face 141 conforms with a profile of a molding cavity 3 defined by closed upper and lower molds 4, 5. The molding cavity 3 is used to form the plastic substrate 15. The composite layer 7 is then put into the upper mold 4. The upper and lower molds 4, 5 are closed such that the composite layer 7 is located just above the molding cavity 3. Finally, molten ABS is injected into the molding cavity 3 from a nozzle 8 to form the plastic substrate 15. The plastic substrate 15 is securely fastened to the adhesion layer 14 of the composite layer 7 to form the cover structure 10.

After that, the cover structure 10, display 20, keypad 30 and PCB (not shown) are assembled together to form the mobile phone 1. Assembly of the mobile phone 1 is well known to persons skilled in the art. Therefore a detailed description of such assembly is omitted herefrom.

The cover structure 10 having the polarizing film 12 allows the mobile phone 1 to provide different visual effects according to different viewing angles. The mobile phone 1 is thus much more aesthetically pleasing to users compared with conventional mobile phones.

It is understood that the invention may be embodied in other forms without departing from the spirit thereof. Thus, the present examples and embodiment are to be considered in all respects as illustrative and not restrictive, and the invention is not to be limited to the details given herein.

What is claimed is:

1. A mobile phone, comprising:
a cover structure comprising an outer composite layer having a polarizing effect to show different decorative effects at different angles of view, and having an inner plastic substrate attached to an inner side of the outer composite layer, a speaker and a microphone being provided in the cover structure;
a printed circuit board provided within the cover structure;
a display; and
a keypad.

2. The mobile phone as claimed in claim 1, wherein the outer composite layer comprises a facial layer, an optical polarizing film, a decorative layer and an adhesion layer in sequence from an outer face of the outer composite layer to the plastic substrate.

3. The mobile phone as claimed in claim 2, wherein the facial layer is a transparent film to protect the polarizing film.

4. The mobile phone as claimed in claim 3, wherein the adhesion layer is made of plastic to protect the decorative layer and combine with the plastic substrate.

5. The mobile phone as claimed in claim 4, wherein the facial layer, the polarizing film the decorative layer and the adhesion layer are heat pressed together to form the outer composite layer.

6. The mobile phone as claimed in claim 5, wherein the plastic substrate is plastic injection molded onto the adhesion layer to combine with the outer composite layer.

7. A cover structure for a portable electronic device, the cover structure comprising:
an outer composite layer having an optical polarizing film and a decorative film under the polarizing film so that the outer composite layer can exhibit different visual effects at different angles of view; and
an inner plastic substrate securely fastened to an inside of the outer composite layer.

8. The cover structure as claimed in claim 7, wherein the outer composite layer further comprises a facial layer on the polarizing film and an adhesion layer below the decorative layer, the adhesion layer being attached to the plastic substrate.

9. The cover structure as claimed in claim 8, wherein the facial layer is a transparent film to protect the polarizing film.

10. The cover structure as claimed in claim 9, wherein the adhesion layer is made of plastic to protect the decorative layer and combine with the plastic substrate.

11. The cover structure as claimed in claim 10, wherein the facial layer, polarizing film, decorative layer and adhesion layer are heat pressed together to form the outer composite layer.

12. The cover structure as claimed in claim 11, wherein the plastic substrate is plastic injection molded to the adhesion layer to combine with the outer composite layer.

13. A method of making a multi-vision effect cover, comprising the steps of:
providing a composite layer with a facial layer, a polarizing film, decorative layer, and an adhesion layer in order by a heat pressing procedure;
providing a pair of complementary molds;
disposing the composite layer in the molds and forcibly pushing the composite layer abut against an inner face of one of said molds;
injecting molten plastic into the molds to form the cover by having the adhesion layer melted and chemically combined with the plastic;
taking the formed cover out of the molds and trimming a contour of the formed cover by removing excessive composite layer if any.
